(19) United States
(12) Patent Application Publication
(10) Pub. No.: US 2020/0351456 A1
(43) Pub. Date: Nov. 5, 2020

(54) IMAGE PROCESSING DEVICE, IMAGE PROCESSING METHOD, AND PROGRAM

(71) Applicant: KDDI CORPORATION, Tokyo (JP)

(72) Inventors: Masahiro SUZUKI, Tokyo (JP); Tomoaki UEDA, Tokyo (JP)

(73) Assignee: KDDI CORPORATION, Tokyo (JP)

(21) Appl. No.: 16/766,072

(22) PCT Filed: Jul. 12, 2018
(86) PCT No.: PCT/JP2018/026383

§ 371 Date: May 21, 2020

(30) Foreign Application Priority Data
Nov. 28, 2017 (JP) 2017-227701

(51) Int. Cl. H04N 5/357; G06T 5/00; G06T 17/00

(52) U.S. Cl. CPC H04N 5/357; G06T 17/00; G06T 5/002

(57) ABSTRACT

An image processing device includes: a region setting unit which sets a region including a target pixel selected from among a plurality of pixels that form an image; a modeling unit that models, with a curved surface, a pixel value distribution of a plurality of pixels that form the region; and a pixel value changing unit which replaces a pixel value of the target pixel by a value of a position that corresponds to the target pixel on the modeled curved surface.

### TECHNICAL FIELD

The present invention relates to an image processing device, an image processing method, and a program, and more specifically relates to a technique for reducing noise in a digital image.

Priority is claimed on Japanese Patent Application No. 2017-227701, filed Nov. 28, 2017, the content of which is incorporated herein by reference.

### BACKGROUND ART

In recent years, solid-state imaging sensors such as CCD (Charged-Coupled Device) and CMOS (Complementary Metal-Oxide-Semiconductor) image sensors have rapidly emerged, resulting in the generation of an enormous number of digital images. These digital images may include various types of noise, such as block noise due to compression, or noise caused by an imaging sensor, such as a CCD or CMOS image sensor. Because digital images can be easily processed by computer and the like, various types of noise reduction processing for reducing the noise included in digital images have been proposed (for example, see Patent Document 1).

### CITATION LIST

### Patent Literature

[Patent Document 1] Japanese Unexamined Patent Application, First Publication No. 2007-42124

### SUMMARY OF THE INVENTION

### Problems to be Solved by the Invention

The technique disclosed in Patent Document 1 includes processing that performs non-linear conversion processing on a plurality of band-limited images representing each of a plurality of different frequency band components of a digital image. Consequently, the calculation amount is large. For example, the processing may take a long time to apply to a large amount of frame data such as that of a moving image.

The present invention has been made in view of these aspects. An exemplary object of the present invention is to provide a noise suppression technique having a high noise reduction effect with respect to a calculated amount.

### Means for Solving the Problem

A first exemplary aspect of the present invention is an image processing device. The device includes: a region setting unit configured to set a region including a target pixel selected from among a plurality of pixels that form an image; a modeling unit configured to model, with a curved surface, a pixel value distribution of a plurality of pixels that form the region; and a pixel value changing unit configured to replace a pixel value of the target pixel by a value of a position that corresponds to the target pixel on the modeled curved surface.

The pixel value of the plurality of pixels that form the image may hold three values that correspond to the respective axes of a three-dimensional color space. The modeling unit may model, with the curved surface, a value distribution for each of the three values corresponding to the respective axes of the three-dimensional color space for the plurality of pixels that form the set region. The pixel value changing unit may replace the three values of the pixel value of the target pixel by values of the position that corresponds to the target pixel on the curved surface modeled for each of the three values.

A target pixel selection unit may be further included which selects a plurality of different target pixels while scanning the image. The region setting unit may set, for each of the plurality of target pixels selected by the target pixel selection unit, a region that includes the respective target pixels.

The modeling unit may model the pixel value distribution of the plurality of pixels that form the set region with an Nth order curved surface (where N is an integer greater than or equal to 2).

The region setting unit may increase the number of the plurality of pixels that form the region as a magnitude of noise in the image increases.

A second exemplary aspect of the present invention is an image processing method. The image processing method includes: setting a region including a target pixel selected from among a plurality of pixels that form an image; modeling, with a curved surface, a pixel value distribution of a plurality of pixels that form the region; and replacing a pixel value of the target pixel by a value of a position that corresponds to the target pixel on the modeled curved surface.

A third exemplary aspect of the present invention is a program. The program causes a computer to execute processing including the steps of: setting a region including a target pixel selected from among a plurality of pixels that form an image; modeling, with a curved surface, a pixel value distribution of a plurality of pixels that form the region; and replacing a pixel value of the target pixel by a value of a position that corresponds to the target pixel on the modeled curved surface.

### Advantageous Effects of Invention

According to the present invention, it is possible to provide a noise suppression technique having a high noise reduction effect with respect to a calculated amount.

### BRIEF DESCRIPTION OF THE DRAWINGS

FIG. 1 is a diagram for describing an outline of an exemplary embodiment.

FIG. 2 is a diagram schematically showing a functional configuration of an image processing device according to the exemplary embodiment.

FIG. 3A is a diagram schematically showing an example of a region set by a region setting unit.

FIG. 3B is a diagram schematically showing the coordinates of each pixel in a region set by the region setting unit.

FIG. 4A is a first diagram for describing pixel replacement processing performed by a pixel value changing unit according to the exemplary embodiment.

FIG. 4B is a second diagram for describing pixel replacement processing performed by the pixel value changing unit according to the exemplary embodiment.

FIG. 5 is a schematic diagram for describing the effect of noise reduction processing performed by the image processing device according to the exemplary embodiment.

FIG. 6 is a flowchart for describing the flow of noise reduction processing performed by the image processing device according to the exemplary embodiment.

### DESCRIPTION OF EMBODIMENTS

### <Outline of Embodiment>

An image processing device according to an exemplary embodiment is a device for reducing noise in a processing target image. Here, the processing target image may be a color image having the three color components of R (red), G (green), and B (blue). Alternatively, it may be a gray scale image such as a radiation image. Furthermore, the image may be a still image such as a photograph, or a moving image. When the processing target image is a moving image, the image of each frame that forms the moving image represents a processing target image. Hereunder, the present specification will be described assuming that the processing target image is a color still image.

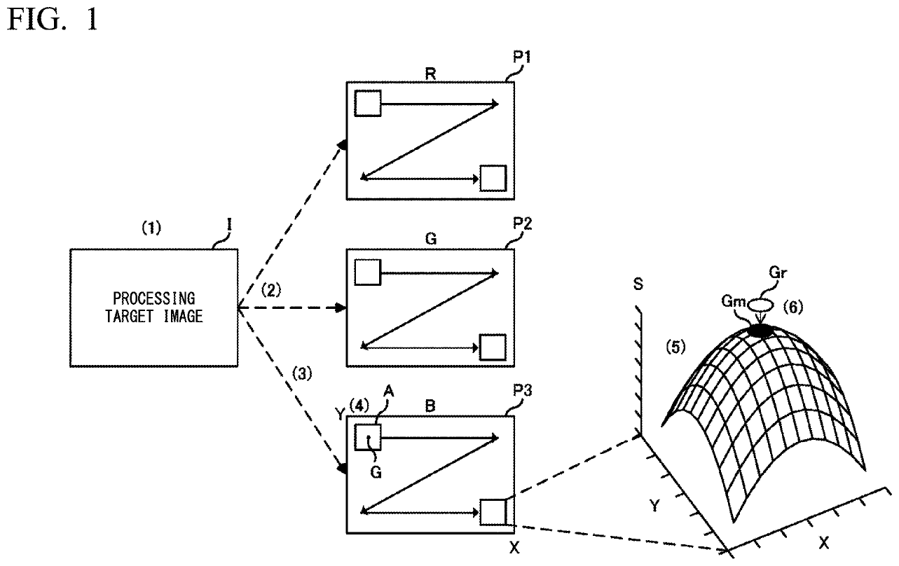

FIG. 1 is a diagram for describing an outline of the exemplary embodiment. The processing steps performed by the image processing device according to the exemplary embodiment will be described in (1) to (6) below while referring to FIG. 1. The description corresponds to (1) to (6) in FIG. 1.

(1) The image processing device according to the exemplary embodiment acquires a processing target image I.

(2) The image processing device decomposes the processing target image I into three image planes, which correspond to the respective axes of a three-dimensional color space. In FIG. 1, the rectangles represented by the reference symbols P1, P2, and P3 are respectively a first image plane P1, a second image plane P2, and a third image plane P3. In FIG. 1, the color space is an RGB color space. Further, the first image plane P1, the second image plane P2, and the third image plane P3 are respectively an R plane, a G plane, and a B plane. However, the image processing device may use an image in another color space (for example, a space using a color difference signal such as YUV or YCbCr) as the processing target image I.

(3) The image processing device sequentially selects a single image plane from among the three image planes. FIG. 1 shows an example in which the image processing device has selected the third image plane (B plane) P3 as the image plane.

(4) The image processing device selects target pixels G from the pixels that form the image plane, and sets regions A that include the target pixels G The image processing device selects a plurality of different target pixels G while scanning the image plane, and sets the respective regions A so as to include the target pixels G The set regions A represent unit regions for the image processing device to execute noise reduction processing.

(5) The image processing device models, with a curved surface, the pixel value distribution of the pixels that form a region A. Specifically, the image processing device uses the least-squares method to obtain, as a model of the pixel value distribution, a quadratic surface approximating the pixel value distribution of the plurality of pixels that form the region A.

(6) The image processing device replaces the pixel value Gr of the target pixel G by a values Gm of the position that corresponds to the target pixel G on the modeled curved surface.

The processing target image I handled by the image processing device according to the exemplary embodiment is a digital image. A digital image includes various types of noise, such as block noise due to compression, or noise caused by an imaging sensor, such as a CCD or CMOS image sensor. These types of noise generally take random values. On the other hand, the image processing device according to the exemplary embodiment approximates the pixel value distribution with a smooth curved surface. This makes it possible to restore a smooth pixel distribution from a pixel distribution whose smoothness has been lost due to the superimposition of noise. As a result, the image processing device according to the exemplary embodiment is capable of reducing the noise of the processing target image I.

### <Functional Configuration of Image Processing Device>

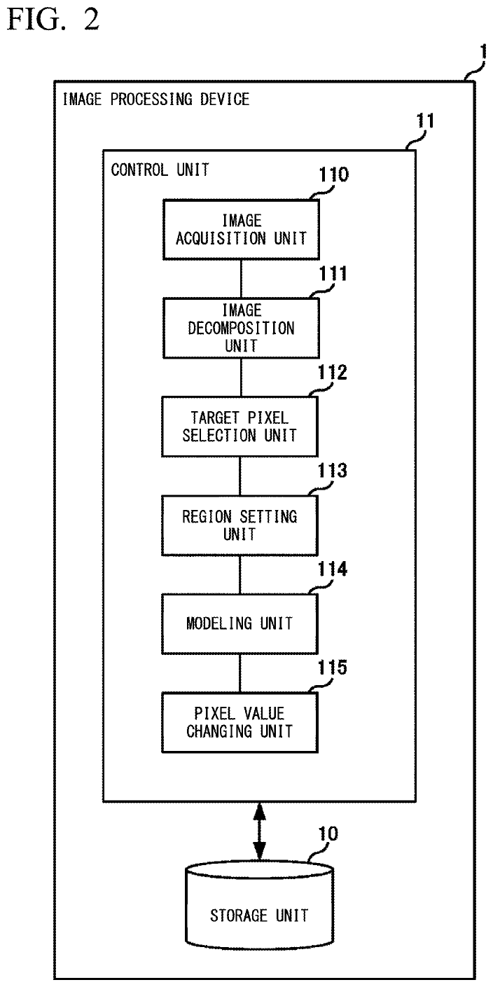

FIG. 2 is a diagram schematically showing a functional configuration of the image processing device 1 according to the exemplary embodiment. The image processing device 1 according to the exemplary embodiment includes a storage unit 10 and a control unit 11.

The storage unit 10 represents a ROM (Read Only Memory) that stores a BIOS (Basic Input Output System) and the like of a computer that realizes the image processing device 1, or a RAM (Random Access Memory) that serves as the work area of the image processing device 1, and a large-capacity storage device such as a hard disk drive (HDD) or a solid state drive (SSD) that stores an OS (Operating System), an application program, and various types of information which are referenced when the application program is executed.

The control unit 11 is a processor such as a CPU (Central Processing Unit) or a GPU (Graphics Processing Unit) of the image processing device 1, and executes a program stored in the storage unit 10 to function as an image acquisition unit 110, an image decomposition unit 111, a target pixel selection unit 112, a region setting unit 113, a modeling unit 114, and a pixel value changing unit 115.

The image acquisition unit 110 acquires the processing target image I, which is the processing target for noise reduction. The image decomposition unit 111 decomposes the processing target image I acquired by the image acquisition unit 110 into three image planes, which correspond to the respective axes of a three-dimensional color space.

The target pixel selection unit 112 sequentially selects a plurality of different target pixels G while scanning a single image plane that has been sequentially selected from among the three image planes that form the processing target image I. The region setting unit 113 sets regions A that include the target pixels G selected by the target pixel selection unit 112 from among the pixels that form the image plane. Specifically, the region setting unit 113 selects, for each of the plurality of target pixels selected by the target pixel selection unit 112, a region A that includes the target pixel G.

The modeling unit 114 models, with a curved surface, the pixel value distribution of the plurality of pixels that form a region A. Specifically, the modeling unit 114 uses the least-squares method to model the pixel value distribution of the plurality of pixels that form a region A with an Nth order curved surface (where N is an integer greater than or equal to 2). The details of the pixel value distribution obtained by the modeling unit 114 will be described later.

The pixel value changing unit 115 replaces the pixel value of a target pixel G by a value of the position that corresponds to the target pixel G on the curved surface modeled by the modeling unit 114. A simple arithmetic operation is sufficient for modeling the pixel distribution using the least-squares method. Consequently, the image processing according to the exemplary embodiment is capable of reducing the noise of the processing target image I with a small calculation cost.

If the processing target image I acquired by the image acquisition unit 110 is a color image generated by, for example, a digital still camera, the pixel values of the pixels that form the processing target image I have three values which correspond to the respective axes of a three-dimensional color space. Generally, the pixel values of the pixels that form the processing target image I have pixel values that correspond to each of the colors R, C, and B. However, depending on the image compression method, the pixel values of the pixels that form the processing target image I may have pixel values that correspond to brightness and color difference signal components.

In any case, the modeling unit 114 models, with a curved surface, a value distribution for each of the three values corresponding to the respective axes of the three-dimensional color space for the pixels that form the region A which has been set by the region setting unit 113. The pixel value changing unit 115 replaces each of the three values by values of the position that corresponds to the target pixel G on the curved surface modeled for each of the three values. As a result, the image processing device 1 is capable of achieving noise reduction, even when the processing target image I is a color image.

Next, the pixel distribution modeling processing performed by the image processing device 1 will be described.

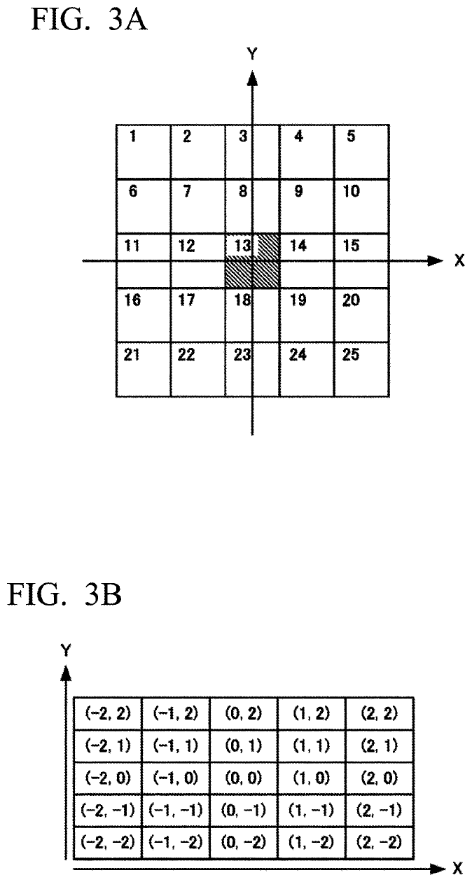

FIGS. 3A and 3B are diagrams schematically showing an example of a region A set by the region setting unit 113. Specifically, FIG. 3A is a schematic diagram showing the region A and the coordinate system set with respect to the region A. FIG. 3B is a schematic diagram showing the coordinates of the pixels in the region A.

In the example shown in FIG. 3A, the region A is a 5×5 pixel rectangular region centered on the target pixel G (indicated by the diagonal lines). The region A includes a total of 25 pixels. Furthermore, a two-dimensional orthogonal coordinate system is set, which has the target pixel G located at the center of the region A as the origin. In FIG. 3A, a coordinate system is set which has the X axis as the horizontal axis, and the Y axis as the vertical axis. Hereunder, for convenience of description, the 25 pixels included in the region A are consecutively numbered from 1 to 25, and the pixel corresponding to the jth pixel is sometimes referred to as pixel j.

A case will be described below in which a 5×5 pixel region A is used. However, it will be apparent to those skilled in the art upon reading the present specification that a region A having an arbitrary size, such as 3×3 pixels, 7×7 pixels, 9×9 pixels, 11×11 pixels, 3×5 pixels, or 7×3 pixels, may be used. Alternatively, an optimal numerical value (number of pixels) may be selected as the size of the region A to obtain a desired processing result. For example, for a region A in a processing target image I in which the magnitude of the noise is large, the region setting unit 113 may increase the number of pixels that form the region A.

For example, when an image is compressed in units of partial regions of the image having a predetermined size, block noise is generated having about the same size as the size of the partial regions. The region setting unit 113 sets the number of pixels that form the region A so that the size of the region A is larger than the size of the block noise. Consequently, when the modeling unit 114 executes modeling processing of the pixel distribution, it is possible to suppress the influence of noise in the region A from being excessively reflected in the model. As a result, the modeling unit 114 is capable of improving the modeling accuracy of the pixel distribution.

The region setting unit 113 may increase the number of pixels that form the region A as the number of pixels that form the processing target image I increases. Compared with a case where the size of the region A is held constant regardless of the number of pixels that form the processing target image I, the ratio between the number of pixels that form the processing target image I and the number of pixels that form the region A is leveled. As a result, the image processing device 1 is capable of stabilizing the processing result of the noise reduction.

The modeling unit 114 models the pixel values of the pixels that form the region A with a quadratic surface. That is to say, the modeling unit 114 models the pixel values S of the pixels that form the region A using formula (1), which is a function S(x,y) of the XY coordinates of the pixels.

S(x,y)=m₁x²+m₂x+m₃y²+m₄y+m₅ (1)

Here, mᵢ (i=1, . . . , 5) are modeling parameters.

Formula (2) is obtained when formula (1) is written down with the X coordinate of the pixel j as xⱼ, the Y coordinate as yⱼ, and S(xⱼ,yⱼ) as sⱼ.

$${s}_{1} = {m}_{1} {x}_{1}^{2} + {m}_{2} {x}_{1} + {m}_{3} {y}_{1}^{2} + {m}_{4} {y}_{1} + {m}_{5} \\ {s}_{2} = {m}_{1} {x}_{2}^{2} + {m}_{2} {x}_{2} + {m}_{3} {y}_{2}^{2} + {m}_{4} {y}_{2} + {m}_{5} \\ … \\ {s}_{25} = {m}_{1} {x}_{25}^{2} + {m}_{2} {x}_{25} + {m}_{3} {y}_{25}^{2} + {m}_{4} {y}_{25} + {m}_{5} \qquad ( 2 )$$

Formula (3) is obtained by expressing formula (2) using a matrix.

$$( \begin{matrix}{s}_{1} \\ {s}_{2} \\ ⋮ \\ {s}_{25}\end{matrix} ) = ( \begin{matrix}{x}_{1}^{2} & {x}_{1} & {y}_{1}^{2} & {y}_{1} & 1 \\ {x}_{2}^{2} & {x}_{2} & {y}_{2}^{2} & {y}_{2} & 1 \\ ⋮ & ⋮ & ⋮ & ⋮ & ⋮ \\ {x}_{25}^{2} & {x}_{25} & {y}_{25}^{2} & {y}_{25} & 1\end{matrix} ) ( \begin{matrix}{m}_{1} \\ {m}_{2} \\ {m}_{3} \\ {m}_{4} \\ {m}_{5}\end{matrix} ) \qquad ( 3 )$$

When formula (3) is written with the left hand side as a vector s, the first term on the right hand side as a matrix X, and the second term on the right hand side as a vector m, formula (3) takes the form of formula (4) below.

s=Xm (4)

Suppose the actual pixel value of a pixel j is represented by dⱼ, and the vector d is a vertical vector having dⱼ as an element. When the pixel value distribution of the region A is modeled with a quadratic surface, the vector d on the right side of formula (3) is expressed in the form shown in formula (5).

d=Xm (5)

In formula (5), the left side is known because it represents the pixel values of the area A. Furthermore, the first term on the right side is known because it is based on the coordinates of each pixel. The second term on the right side is unknown because it is a modeling parameter. Here, an error vector e representing the modeling error is defined by the following formula (6).

e=d−Xm (6)

Formula (5) is an overdetermined problem because the number of data is larger than the number of modeling parameters that are unknown. At this time, a vector mₒₚₜ that minimizes e^{T}e, which is the two-norm of the error vector e, is known as a least-squares solution, and is represented by the following formula (7).

mₒₚₜ=(X^{T}X)⁻¹X^{T}d (7)

Here, T represents the transpose of a matrix, and −1 represents an inverse matrix.

As shown in FIG. 3B, the xy-coordinates of the pixels included in the region A are set such that the center, that is to say, the target pixel G, becomes the origin. Formula (8) is obtained when the right side of formula (7) is written down after substitution with the coordinates.

$$( \begin{matrix}{m}_{1} \\ {m}_{2} \\ {m}_{3} \\ {m}_{4} \\ {m}_{5}\end{matrix} ) = {( \begin{matrix}170 & 0 & 100 & 0 & 50 \\ 0 & 50 & 0 & 0 & 0 \\ 100 & 0 & 170 & 0 & 50 \\ 0 & 0 & 0 & 50 & 0 \\ 50 & 0 & 50 & 0 & 25\end{matrix} )}^{- 1} ( \begin{matrix}{\sum }_{j = 1}^{25} {x}_{j}^{2} {d}_{j} \\ {\sum }_{j = 1}^{25} {x}_{j} {d}_{j} \\ {\sum }_{j = 1}^{25} {y}_{j}^{2} {d}_{j} \\ {\sum }_{j = 1}^{25} {y}_{j} {d}_{j} \\ {\sum }_{j = 1}^{25} {d}_{j}\end{matrix} ) \qquad ( 8 )$$

The calculation in formula (8) enables the modeling unit 114 to obtain optimal modeling parameters in the context of minimizing the two-norm in formula (6). As shown in FIG. 3A, the 25 pixels included in the region A are assigned consecutive numbers j (from 1 to 25). As shown in FIG. 3B, the coordinates (x₁,y₁) of the pixel (j=1) are (−2,2). Similarly, the coordinates (x₂,y₂) of the pixel (j=2) are (−1,2). The coordinates (x₃,y₃) of the pixel (j=3) are (0,2). The other pixels are as shown in FIG. 3A and FIG. 3B. The coordinates (x₁₃,y₁₃) of the target pixel G (j=13) are (0,0).

The target pixel G (j=13) represents the origin in the region A. Consequently, the coordinates (x₁₃,y₁₃) are (0,0). Therefore, the value Gm=S(0,0) of the position that corresponds to the target pixel G on the modeled curved surface is given by formula (9) below.

Gm=S(0,0)=m₁0²+m₂0+m₃0²+m₄×0+m₅=m₅ (9)

As a result, the value Gm of the position that corresponds to the target pixel G on the modeled curved surface is m₅, which is one of the modeling parameters.

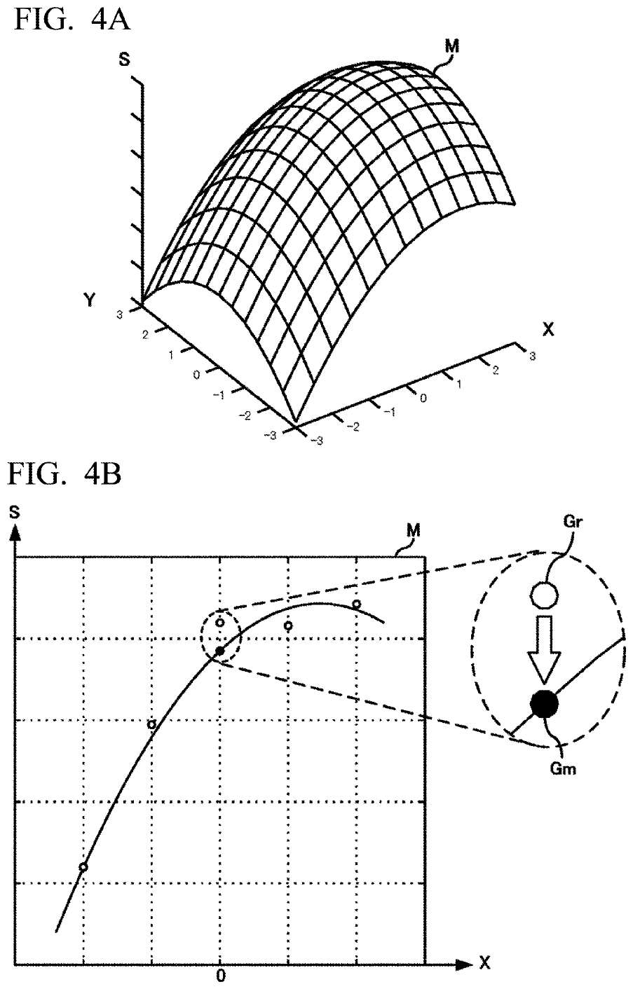

FIG. 4A and FIG. 4B are diagrams for describing the pixel replacement processing performed by the pixel value changing unit 115 according to the exemplary embodiment. Specifically, FIG. 4A is a schematic diagram showing an overview of a quadratic surface M generated by the modeling unit 114. Further, FIG. 4B is a diagram showing a quadratic surface M in the XS plane (a plane in which the Y coordinate is zero).

As shown in FIG. 4B, the quadratic surface M in the XS plane is a parabola. The pixel value changing unit 115 replaces the pixel value Gr of the target pixel G with the value Gm (that is to say, the value of the modeled parameter m₅). The pixel value changing unit 115 is capable of obtaining a processing target image I having reduced noise as a result of generating a new image in which the pixel value Gr of the target pixel G has been replaced with the value m₅ for all of the regions A set by the region setting unit 113.

As described above, the pixel value changing unit 115 only needs to be able to acquire the value of m₅ among the five modeling parameters. Therefore, the following formula (10) is obtained when formula (8) is expanded to extract m₅.

$${m}_{5} = {\sum }_{j = 1}^{25} \{ \frac{27}{175} - \frac{{x}_{j}^{2} + {y}_{j}^{2}}{35} \} {d}_{j} = {v}^{T} d \qquad ( 10 )$$

Note that the vector v=(−0.074286, 0.011429, 0.040000, 0.011429, 0.074286, 0.011429, 0.097143, 0.125714, 0.097143, 0.011429, 0.040000, 0.125714, 0.154286, 0.125714, 0.040000, 0.011429, 0.097143, 0.125714, 0.097143, 0.011429, 0.074286, 0.011429, 0.040000, 0.011429, −0.074286)^{T}.

The vector v can be calculated by substituting the coordinates of the pixels shown in FIG. 3B into formula (10). Formula (10) can be regarded as a formula that replaces the pixel value Gr of the target pixel G with a weighted average of the pixel values of a plurality of pixels that form the area A. In this case, the vector v can be considered the kernel of the smoothing filter. It can be seen that the absolute value of the weight of each pixel is larger close to the target pixel G.

The storage unit 10 may hold the vector v. In this case, when the pixel value distribution of the plurality of pixels that form the region A is modeled using a quadratic surface, the pixel value changing unit 115 acquires the vector by referring to the storage unit 10. As a result, the calculation of an inverse matrix and the like can be omitted. Consequently, the image processing device 1 according to the exemplary embodiment is capable of accelerating the noise reduction processing of the processing target image I.

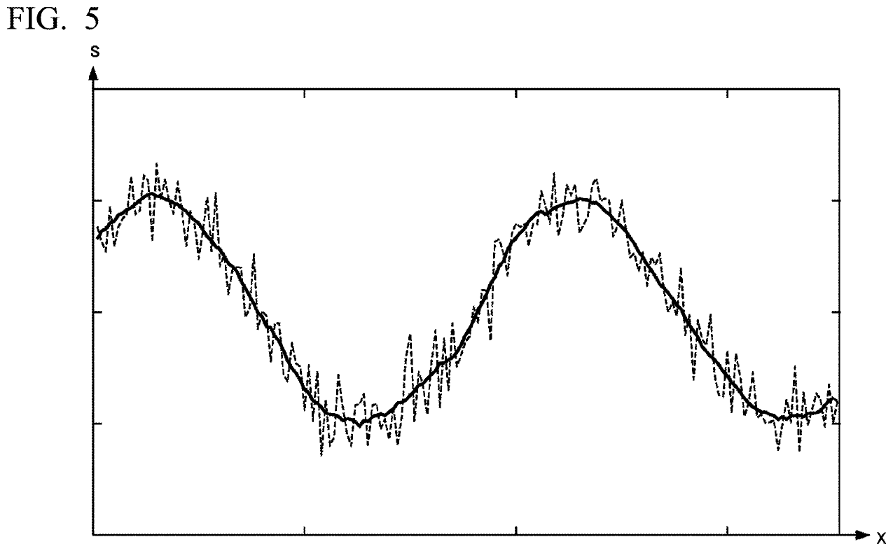

FIG. 5 is a schematic diagram for describing the effect of the noise reduction processing performed by the image processing device 1 according to the exemplary embodiment. For convenience of illustration, FIG. 5 plots the pixel value S with respect to the X coordinate of the processing target image I, while the Y coordinate is held constant. In FIG. 5, the graph represented by the broken line represents the pixel values of the processing target image I before the noise reduction processing is performed by the image processing device 1. On the other hand, the graph indicated by the solid line represents the pixel values of the processing target image I after the noise reduction processing is performed by the image processing device 1.

Generally, when noise is superimposed on image data, there is an increase in the variation of the pixel values. As shown in FIG. 5, the variation in the values of the pixel values of the processing target image I after the noise reduction processing is performed by the image processing device 1 is smaller than that of the pixel values of the processing target image I before the noise reduction processing is performed by the image processing device 1. This indicates that the noise has been reduced.

### <Processing Flow of Noise Reduction Processing Performed by Image Processing Device 1>

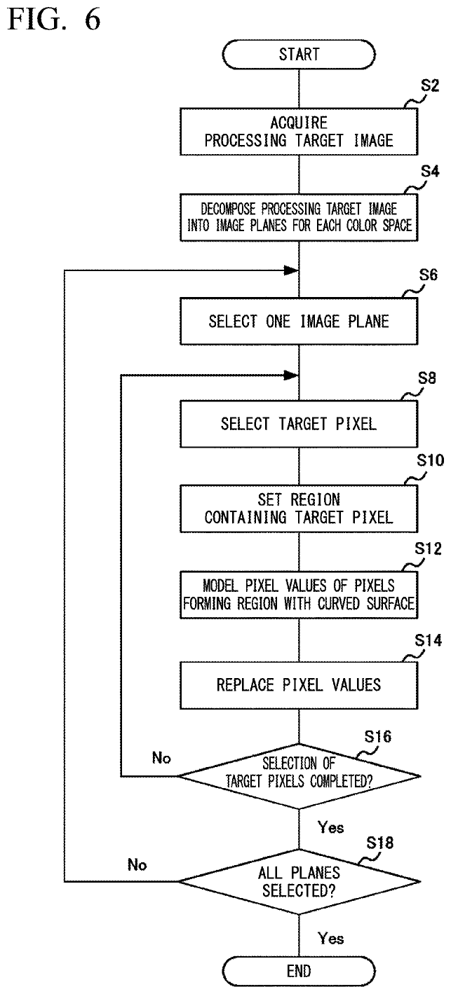

FIG. 6 is a flowchart for describing the flow of the noise reduction processing performed by the image processing device 1 according to the exemplary embodiment. The processing in the present flowchart is started, for example, when the image processing device 1 is activated.

The image acquisition unit 110 acquires the processing target image I, which is the target of the noise reduction processing (S2). If the processing target image I is a color image, the image decomposition unit 111 decomposes the processing target image I into an image plane for each color space (S4). The target pixel selection unit 112 sequentially selects the image planes one by one (S6).

The target pixel selection unit 112 selects, while scanning the selected image plane, one pixel among the plurality of pixels that form the image plane as the target pixel G (S8). The region setting unit 113 sets a region A which includes the target pixel G that has been selected by the target pixel selection unit 112 (S10). The modeling unit 114 models the pixel values of each of the pixels that form the region A according to a quadratic surface (S12). The pixel value changing unit 115 replaces the pixel value Gr of the target pixel G by a value Gm of the position that corresponds to the target pixel G on the quadratic curved surface modeled by the modeling unit 114 (S14).

The image processing device 1 repeats the processing from step S8 to step S14 until the target pixel selection unit 112 has finished selecting the target pixels G from the image plane (S16:No). The image processing device 1 returns to step S6 and repeats the processing from step S6 to step S16 when the target pixel selection unit 112 finishes selecting the target pixels G in one image plane (S16:Yes), but has not yet selected all of the image planes (S18:No).

When the target pixel selection unit 112 has selected all of the image planes (S18:Yes), the processing in the flowchart ends.

### <Effects of Image Processing Device 1 According to Exemplary Embodiment>

As described above, according to the image processing device 1 of the exemplary embodiment, it is possible to provide a noise suppression technique having a high noise reduction effect with respect to a calculated amount.

The present invention has been described above using an exemplary embodiment. However, the technical scope of the present invention is not limited to the scope described in the exemplary embodiment above, and various modifications and changes can be made within the scope of the gist thereof. For example, the specific mode in which the device is distributed and integrated is not limited to the above exemplary embodiment. Further, part or all of the device may be functionally or physically configured by distributing and integrating arbitrary units. Moreover, new embodiments that are generated by arbitrary combinations of a plurality of exemplary embodiments are also included in the exemplary embodiment of the present invention. The effects of the new exemplary embodiments generated by such combinations have the effects of the original exemplary embodiment. Such modifications will be described below.

### <First Modification>

A case where the modeling unit 114 models, with a quadratic curved surface, the pixel value distribution of the plurality of pixels that form the region A has been described above. However, the order of the curved surface modeled by the modeling unit 114 is not limited to the second order, and may be a third order or higher. As the order of the curved surface modeled by the modeling unit 114 increases, a larger change in the pixel values of the pixels that form the processing target image I can be modeled. Therefore, when foresight information is obtained that indicates the image of the processing target image I contains many high-frequency components, the modeling unit 114 may model the pixel value distribution of the plurality of pixels that form the region A with a third or higher order surface.

For example, when the modeling unit 114 models the pixel value distribution of the pixels that form the area A on a quartic surface, the equation corresponding to formula (1) is written as shown in formula (11).

S(x,y)=m₁x⁴+m₂x³+m₃x²+m₄x+m₅y⁴+m₆y³+m₇y²+m₈y+m₉ (11)

Furthermore, the formula corresponding to formula (3) is written as shown in formula (12).

$$( \begin{matrix}{s}_{1} \\ {s}_{2} \\ ⋮ \\ {s}_{25}\end{matrix} ) = ( \begin{matrix}{x}_{1}^{4} & {x}_{1}^{3} & {x}_{1}^{2} & {x}_{1} & {y}_{1}^{4} & {y}_{1}^{3} & {y}_{1}^{2} & {y}_{1} & 1 \\ {x}_{2}^{4} & {x}_{2}^{3} & {x}_{2}^{2} & {x}_{2} & {y}_{2}^{4} & {y}_{2}^{3} & {y}_{2}^{2} & {y}_{2} & 1 \\ ⋮ & ⋮ & ⋮ & ⋮ & ⋮ & ⋮ & ⋮ & ⋮ & ⋮ \\ {x}_{25}^{4} & {x}_{25}^{3} & {x}_{25}^{2} & {x}_{25} & {y}_{25}^{4} & {y}_{25}^{3} & {y}_{25}^{2} & {y}_{25} & 1\end{matrix} ) ( \begin{matrix}{m}_{1} \\ {m}_{2} \\ {m}_{3} \\ {m}_{4} \\ {m}_{5} \\ {m}_{6} \\ {m}_{7} \\ {m}_{8} \\ {m}_{9}\end{matrix} ) \qquad ( 12 )$$

When formula (12) is written with the left hand side as a vector s, the first term on the right hand side as a matrix X, and the second term on the right hand side as a vector m, formula (12) takes the same form as formula (4). Therefore, the least-squares error solution mₒₚₜ in formula (12) takes the same form as formula (7). As a result, formula (7) takes the same form regardless of the order of the curved surface used to model the pixel value distribution of the plurality of pixels that form the region A.

When the modeling unit 114 models the pixel value distribution of the pixels that form the area A on a quartic surface, the equation corresponding to formula (8) takes the form of formula (13).

$$( \begin{matrix}{m}_{1} \\ {m}_{2} \\ {m}_{3} \\ {m}_{4} \\ {m}_{5} \\ {m}_{6} \\ {m}_{7} \\ {m}_{8} \\ {m}_{9}\end{matrix} ) = {( \begin{matrix}2570 & 0 & 650 & 0 & 1156 & 0 & 340 & 0 & 170 \\ 0 & 650 & 0 & 170 & 0 & 0 & 0 & 0 & 0 \\ 650 & 0 & 170 & 0 & 340 & 0 & 100 & 0 & 50 \\ 0 & 170 & 0 & 50 & 0 & 0 & 0 & 0 & 0 \\ 1156 & 0 & 340 & 0 & 2570 & 0 & 650 & 0 & 170 \\ 0 & 0 & 0 & 0 & 0 & 650 & 0 & 170 & 0 \\ 340 & 0 & 100 & 0 & 650 & 0 & 170 & 0 & 50 \\ 0 & 0 & 0 & 0 & 0 & 170 & 0 & 50 & 0 \\ 170 & 0 & 50 & 0 & 170 & 0 & 50 & 0 & 25\end{matrix} )}^{- 1} ( \begin{matrix}{\sum }_{j = 1}^{25} {x}_{j}^{4} {d}_{j} \\ {\sum }_{j = 1}^{25} {x}_{j}^{3} {d}_{j} \\ {\sum }_{j = 1}^{25} {x}_{j}^{2} {d}_{j} \\ {\sum }_{j = 1}^{25} {x}_{j} {d}_{j} \\ {\sum }_{j = 1}^{25} {y}_{j}^{4} {d}_{j} \\ {\sum }_{j = 1}^{25} {y}_{j}^{3} {d}_{j} \\ {\sum }_{j = 1}^{25} {y}_{j}^{2} {d}_{j} \\ {\sum }_{j = 1}^{25} {y}_{j} {d}_{j} \\ {\sum }_{j = 1}^{25} {d}_{j}\end{matrix} ) \qquad ( 13 )$$

In formula (13), the vector corresponding to the vector v in formula (9) becomes v=(−0.04, −0.04, 0.16, −0.04, −0.04, −0.04, −0.04, 0.16, −0.04, −0.04, 0.16, 0.16, 0.36, 0.16, 0.16, −0.04, −0.04, 0.16, −0.04, −0.04, −0.04, −0.04, 0.16, −0.04, −0.04)^{T}.

The storage unit 10 may hold a calculation result of the vector v for different orders in advance. In this case, the pixel value changing unit 115 refers to the storage unit 10 to acquire the vector v corresponding to each order. As a result, even when the pixel value distribution of the plurality of pixels that form the region A is modeled by a different order, the calculation of the inverse matrix and the like by the modeling unit 114 can be omitted.

### <Second Modification>

A case where noise is reduced by modeling the processing target image I with a quadratic surface has been described above. In addition, the noise reduction processing may be further duplicated by modeling, with a quadratic surface, the image obtained by performing a single iteration of the noise reduction processing. As a result, noise reduction can be executed more effectively.

### INDUSTRIAL APPLICABILITY

According to the present invention, it is possible to provide a noise suppression technique having a high noise reduction effect with respect to a calculated amount.

### REFERENCE SIGNS LIST

1 Image processing device
10 Storage unit
11 Control unit
110 Image acquisition unit
111 Image decomposition unit
112 Target pixel selection unit
113 Region setting unit
114 Modeling unit
115 Pixel value changing unit

1. An image processing device comprising:
a region setting unit configured to set a region including a target pixel selected from among a plurality of pixels that form an image;
a modeling unit configured to model, with a curved surface, a pixel value distribution of a plurality of pixels that form the region; and
a pixel value changing unit configured to replace a pixel value of the target pixel by a value of a position that corresponds to the target pixel on the modeled curved surface.

2. The image processing device according to claim 1, wherein:
the pixel value of the plurality of pixels that form the image holds three values that correspond to the respective axes of a three-dimensional color space;
the modeling unit models, with the curved surface, a value distribution for each of the three values corresponding the respective axis of the three-dimensional color space for the plurality of pixels that form the set region; and
the pixel value changing unit replaces the three values of the pixel value of the target pixel by values of the position that corresponds to the target pixel on the curved surface modeled for each of the three values.

3. The image processing device according to claim 1, further comprising
a target pixel selection unit configured to select a plurality of different target pixels while scanning the image, wherein
the region setting unit sets, for each of the plurality of target pixels selected by the target pixel selection unit, a region that includes the respective target pixels.

4. The image processing device according to claim 1, wherein
the modeling unit models the pixel value distribution of the plurality of pixels that form the set region with an Nth order curved surface (where N is an integer greater than or equal to 2).

5. The image processing device according to claim 1, wherein
the region setting unit increases the number of the plurality of pixels that form the region as a magnitude of noise in the image increases.

6. An image processing method comprising:
setting a region including a target pixel selected from among a plurality of pixels that form an image;
modeling, with a curved surface, a pixel value distribution of a plurality of pixels that form the region; and
replacing a pixel value of the target pixel by a value of a position that corresponds to the target pixel on the modeled curved surface.

7. A non-transitory computer-readable recording medium storing a program which causes a computer to execute processing including:
setting a region including a target pixel selected from among a plurality of pixels that form an image;
modeling, with a curved surface, a pixel value distribution of a plurality of pixels that form the region; and
replacing a pixel value of the target pixel by a value of a position that corresponds to the target pixel on the modeled curved surface.
